(19) United States
(12) Patent Application Publication
(10) Pub. No.: US 2019/0055042 A1
(43) Pub. Date: Feb. 21, 2019

(54) Vacuum Sealer With Two-Stage Sealing

(71) Applicant: Hamilton Beach Brands, Inc., Glen Allen, VA (US)

(72) Inventors: Kevin L. Leppert, Lanexa, VA (US); David Matthew Schandel, Henrico, VA (US)

(21) Appl. No.: 16/100,799

(22) Filed: Aug. 10, 2018

Related U.S. Application Data
(60) Provisional application No. 62/545,531, filed on Aug. 15, 2017.

(51) Int. Cl. B65B 51/14; B65B 31/04; B29C 65/20; B29C 65/30; B29C 65/00

(52) U.S. Cl. CPC B65B 51/146; B65B 31/048; B29C 66/8491; B29C 65/30; B29C 65/20

(57) ABSTRACT

An improved vacuum sealer having a sealing bar with a plurality of heating elements, where the heating elements ultimately seal the entire length of a polymeric bag, but may be activated independently such that a portion of the bag may first be sealed, after which a vacuum force is applied to the bag such that the internal air is removed, after which the remainder the of the bag is sealed through application of power to the second heating element.

### CROSS REFERENCE TO RELATED APPLICATIONS

This application claims priority to U.S. Provisional Patent Application No. 62/545,531, filed Aug. 15, 2017, the entire contents of which are incorporated herein by reference.

### BACKGROUND OF THE DISCLOSURE

The present disclosure relates generally to small appliances, and more particularly to vacuum sealers.

Vacuum sealers are small appliances that are used to vacuum seal items (such as foodstuffs) in a polymeric or plastic bag. Vacuum sealing helps preserve food. Conventional vacuum sealers comprise a vacuum chamber and a vacuum pump for pumping air out of the open end of a plastic bag, and an elongated heat sealing bar to seal the open end once the air has been pumped out of the bag.

The bags are typically formed from a roll of bag stock that has two opposing side edges that are factory sealed. A desired length of bag stock is cut off the roll, such that the cut bag stock has two opposing sealed side edges and two opposing open ends. One end of the cut bag stock is pre-sealed when pulled off the roll, much like a produce bag in a grocery store. Or, the cut portion is open but then sealed using a heat sealing bar to create a bag with one open end for receiving the item (or items) to be sealed. The item is placed in the bag and the open edge is positioned within the vacuum chamber. The vacuum pump is activated to create a vacuum in the vacuum chamber and the air is vacuumed out of the bag. When the air has been evacuated from the bag, the open end of the bag is sealed by the heat sealing bar.

The bag stock typically comprises one side that has a smooth inner surface and an opposing side that has a textured inner surface (the outer surfaces of both sides may be smooth or textured). The texture on the inner surface of one side forms a plurality of small channels through which air escapes as the air is vacuumed out of the bag.

When attempting to seal wet or moist items or liquids, some of the liquid in the bag might be vacuumed out of the bag along with the air. The escaping liquid is undesirable as the liquid is pulled into the vacuum chamber, which can create a mess that is difficult to clean up, onto the sealing surface of the bag, which can prevent a good heat seal, and/or into the vacuum pump, which can damage the vacuum pump.

There is therefore a need to create a vacuum sealer that can seal wet or moist items or liquids while reducing the risk of liquid escaping from the bag when the air is vacuumed out of the bag. The vacuum sealer of the following disclosure accomplishes the above and other objectives and overcomes at least the above-described disadvantages of conventional vacuum sealers.

### SUMMARY OF THE INVENTION

In an embodiment, a vacuum sealer comprises a housing having an upper portion and a lower portion, the lower portion having a top surface; a lid pivotably attached to the housing, and movable between a closed position, covering at least a portion of the top surface, and an open position, exposing the top surface; wherein the top surface defines a first cavity and the lid defines an opposing second cavity in an underside of the lid, the first cavity and the second cavity being engaged together or to one another in the closed position of the lid to form a sealed vacuum chamber therebetween. The vacuum sealer further comprises a pump in fluid communication with the vacuum chamber to withdraw air from the vacuum chamber and create a vacuum therein, the sealed vacuum chamber being configured to receive an open end of a polymeric bag therebetween to withdraw air therefrom via activation of the pump; a sealing bar, the sealing bar having a first heating ribbon and a second heating ribbon, the first heating ribbon and the second heating ribbon each having a predetermined length and a common longitudinal axis; a thermally insulating backing strip opposing the first heating ribbon and second heating ribbon, the sealing bar and the backing strip being configured to heat seal a portion of the polymeric bag positioned therebetween through the application of power from a power supply to the first heating ribbon and the second heating ribbon.

In another embodiment, a vacuum sealer comprises a housing having an upper portion and a lower portion, the lower portion having a top surface; a lid pivotably attached to the housing, and movable between a closed position, covering at least a portion of the top surface, and an open position, exposing the top surface; wherein the top surface defines a first cavity and the lid defines an opposing second cavity in an underside of the lid, the first cavity and the second cavity being engaged in the closed position of the lid to form a sealed vacuum chamber therebetween. The vacuum sealer further comprises a pump in fluid communication with the vacuum chamber to withdraw air from the vacuum chamber and create a vacuum therein, the sealed vacuum chamber being configured to receive an open end of a polymeric bag therebetween to withdraw air therefrom via activation of the pump; a first sealing bar having a first heating ribbon; a second sealing bar spaced apart from and generally parallel to the first sealing bar, the second sealing bar having a second heating ribbon, the first heating ribbon and the second heating ribbon are secured such that a portion of the first heating ribbon laterally overlaps at least a portion of the second heating ribbon; a third sealing bar secured proximate to the overlapping portions of the first sealing bar and the second sealing bar, the third sealing bar having a third heating ribbon secured such that the third heating ribbon intersects with both the first heating ribbon and the second heating ribbon; and a thermally insulating backing strip opposing the first, second, and third heating ribbons, the sealing bars and the backing strip being configured to heat seal a portion of the polymeric bag positioned therebetween through the application of power from a power supply to the sealing bars.

In yet another embodiment, a vacuum sealer comprises a housing having an upper portion and a lower portion, the lower portion having a top surface; a lid pivotably attached to the housing, and movable between a closed position, covering at least a portion of the top surface, and an open position, exposing the top surface; wherein the top surface defines a first cavity and the lid defines an opposing second cavity in an underside of the lid, the first cavity and the second cavity being engaged in the closed position of the lid to form a sealed vacuum chamber therebetween. The vacuum sealer further comprises a pump in fluid communication with the vacuum chamber to withdraw air from the vacuum chamber and create a vacuum therein, the sealed vacuum chamber being configured to receive an open end of a polymeric bag therebetween to withdraw air therefrom via activation of the pump; at least one sealing bar, the at least one sealing bar having at least two heating ribbons; wherein the at least two heating ribbons are each independently connected to a power supply such that the at least two heating ribbons can expand and contract during activation; a thermally insulating backing strip opposing the at least two heating ribbons, the at least one sealing bar and the backing strip being configured to heat seal a portion of the polymeric bag positioned therebetween through the application of power from the power supply to the at least two heating ribbons.

In yet another embodiment, a polymeric bag holding mechanism for a vacuum sealer comprises a main body having at least a first end; a first latch mechanism movably disposed on the first end of the main body. The latch mechanism comprises a first clamp connected to a carriage at a first pivot point; the carriage being disposed within a recess such that the carriage moves laterally within the recess at the depression and release of a first button; wherein the first clamp is configured to open and close via the movement of the first pivot point within a channel as the carriage moves laterally within the recess. The bag holding mechanism further comprises a second latch mechanism disposed on the main body in line with the first latch mechanism, the second latch mechanism comprising a second clamp connected to a mount at a second pivot point, and configured to open and close at the depression and release of a second button.

In yet another embodiment, an improved sealing bar for a vacuum sealer, comprises a support bar having four long surfaces and two short surfaces; one or more opposing longitudinal channels linearly disposed within the support bar, each of the one or more opposing longitudinal channels being sealed with a channel cover, each of the channel covers having a mounting hole, each of the mounting holes facing outwardly from one of the four long surfaces; a heating bar disposed on the long surface of the support bar opposite the long surface displaying the one or more mounting holes; and a high temperature tape covering the heating bar and all surfaces of the support bar except for the long surface displaying the one or more mounting holes.

In yet another embodiment, a method for using a vacuum sealer, comprises receiving an open end of a polymeric bag into a housing having an upper portion and a lower portion, the lower portion having a top surface, and a lid pivotably attached to the housing, and movable between a closed position, covering at least a portion of the top surface, and an open position, exposing the top surface, wherein the top surface defines a first cavity and the lid defines an opposing second cavity in an underside of the lid, the first cavity and the second cavity being engaged in the closed position of the lid to form a sealed vacuum chamber therebetween; sealing a first portion of the polymeric bag by applying power to a first heating ribbon on a sealing bar; applying a vacuum force to at least an unsealed, second portion of the polymeric bag by a pump in fluid communication with the vacuum chamber to withdraw air from the vacuum chamber and create a vacuum therein; and sealing the second portion of the polymeric bag by applying power to a second heating ribbon axially aligned with the first heating ribbon on the sealing bar, such that the open end of the polymeric bag is completely sealed.

In yet another embodiment, a method for using a vacuum sealer comprises receiving an open end of a polymeric bag into a housing having an upper portion and a lower portion, the lower portion having a top surface, and a lid pivotably attached to the housing, and movable between a closed position, covering at least a portion of the top surface, and an open position, exposing the top surface, wherein the top surface defines a first cavity and the lid defines an opposing second cavity in an underside of the lid, the first cavity and the second cavity being engaged in the closed position of the lid to form a sealed vacuum chamber therebetween; sealing a first portion of the polymeric bag by applying power to a first heating ribbon on a sealing bar; sealing a second portion of the polymeric bag by applying power to a second heating ribbon, the second heating ribbon being generally parallel to and spaced apart from the first heating bar; applying a vacuum force to the an unsealed third portion of the polymeric bag by a pump in fluid communication with the vacuum chamber to withdraw air from the vacuum chamber and create a vacuum therein; and sealing the third portion of the polymeric bag by applying power to a third heating ribbon secured proximate to the first heating bar and second heating bar such that the third heating ribbon intersects with both the first heating ribbon and the second heating ribbon, such that the open end of the polymeric bag is completely sealed.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments that are presently preferred. It should be understood, however, that the disclosure is not limited to the precise arrangements and instrumentalities shown. In the drawings:

FIG. 1 is a front and top perspective view of a vacuum sealer, with the lid closed, according to one embodiment of the present disclosure.

FIG. 2 is a front and top perspective view of the vacuum sealer of FIG. 1, with the lid open.

FIGS. 3A and 3B are top plan views of two different heating ribbon options of a vacuum sealer of embodiments of the present disclosure.

FIGS. 4A-4C are side elevational views of three different options for providing electrical power to a heating ribbon of a vacuum sealer of embodiments of the present disclosure.

FIGS. 5A and 5B are top plan views of two different vacuum sealer bags, according to alternative embodiments of the present disclosure.

FIGS. 6A and 6B are top plan views of two different heating ribbon options of a vacuum sealer of embodiments of the present disclosure.

FIG. 7 is a front and top perspective view of a vacuum sealer, according to an alternative embodiment of the present disclosure.

FIGS. 8A-8C are side elevational views showing the operation of a bag clamping mechanism of the vacuum sealer of FIG. 7.

FIG. 9 is a partial front and top perspective view of an alternative position of the bag clamping mechanism of the vacuum sealer of FIG. 7.

FIG. 10A is a bottom perspective view of a prior art sealing bar of a vacuum sealer.

FIG. 10B is a top perspective view of a prior art sealing bar of a vacuum sealer.

FIG. 11A is a bottom perspective view of a sealing bar of a vacuum sealer, according to an alternative embodiment of the present disclosure.

FIG. 11B is a top perspective view of a sealing bar of a vacuum sealer, according to an alternative embodiment of the present disclosure.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the vacuum sealer, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

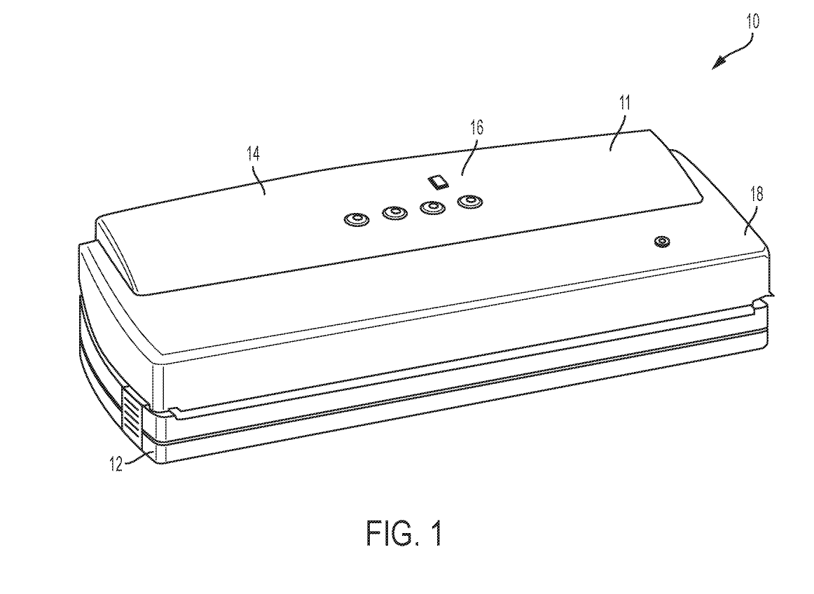

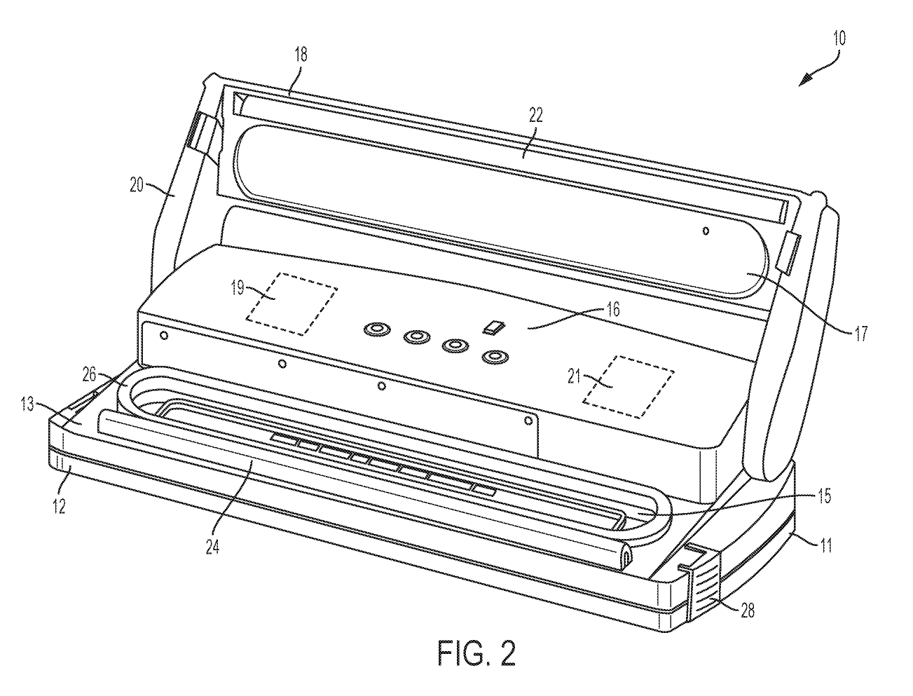

Embodiments of the present disclosure comprise a vacuum sealer with a multi-segment heating ribbon on the heating bar. The heating ribbon may have two or more segments, as described below. Referring to the drawings in detail, wherein like numerals indicate like elements throughout, FIGS. 1-4C illustrate a vacuum sealer 10 of a first preferred embodiment of the present disclosure. The vacuum sealer 10 comprises a housing 11 with a lower portion 12 adapted to sit on a surface (such as a countertop) during use and an upper portion 14. The lower portion 12 has a top surface 13, as shown in FIG. 2. The upper portion 14 has a control panel 16 that controls the operation of the vacuum sealer 10. The vacuum sealer 10 also has a lid 18 pivotably attached to the housing 11. The lid 18 is movable between a closed position (seen in FIG. 1) in which the lid 18 is covering at least a portion of the top surface 13 of the lower portion 12, and an open position (seen in FIG. 2) that exposes the top surface 13 of the lower portion 12. The lid 18 is preferably supported by opposing arms 20 pivotably attached to the lower portion 12. The top surface 13 defines a first cavity 15 and the lid 18 defines an opposing second cavity 17 in an underside of the lid 18. The first cavity 15 and the second cavity 17 are engaged together or to one another in the closed position of the lid 18 to form a sealed vacuum chamber 26 therebetween.

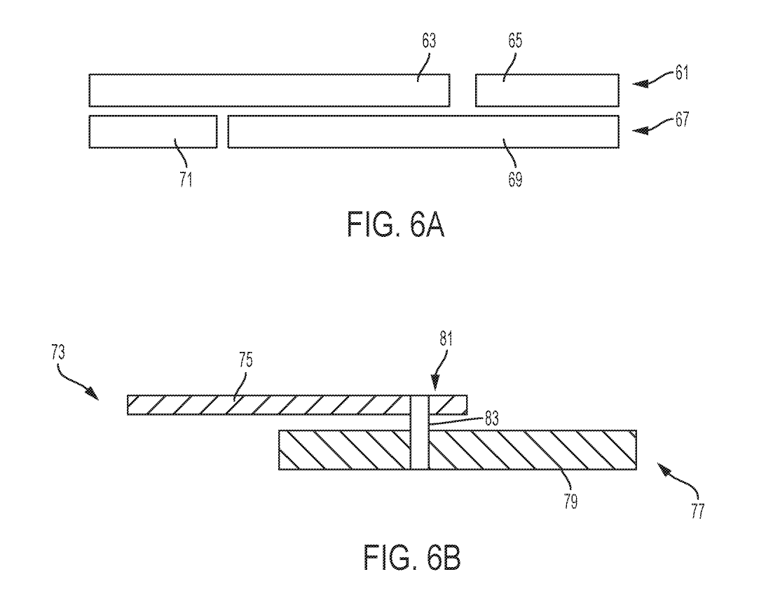

The control panel 16 comprises one or more input elements (buttons, switches, knobs, etc.) and/or one or more output elements (alphanumeric displays, lights, buzzers, etc.). A sealing bar 22 is secured on the underside of the lid 18, although it could be located in the lower portion or any other suitable location. The sealing bar 22 comprises one or more heating ribbons (described further below) that heat up when electricity is applied during a sealing operation to heat seal an opening of a bag. The corresponding top surface 13 of the lower portion 12 preferably has a thermally insulating backing strip 24 that is positioned such that a bag is sandwiched between the sealing bar 22 and the thermally insulating backing strip 24 when the lid 18 is in the closed position. In an alternate embodiment, the thermally insulating backing strip 24 is located in the lid 18, while the sealing bar 22 (or, as shown in FIGS. 6A and 6B, the sealing bars) is/are located in the corresponding top surface 13 of the lower portion 12 of the housing 11. The vacuum chamber 26 seals around the open end of the bag when the lid 18 is in the closed position. During operation of the device, air is vacuumed out of the vacuum chamber 26, which in turn vacuums air out of the interior of the bag via the open end. A pump 21 (show in phantom in FIG. 2) is housed inside the housing 11, and is in fluid communication with the vacuum chamber 26 to withdraw air from the vacuum chamber 26 and create a vacuum therein. The sealed vacuum chamber 26 between the first and second cavities 15, 17 is configured to receive an open end of a polymeric or plastic bag (not shown) therebetween to withdraw air therefrom via activation of the pump 21. A latch 28 is provided to secure the lid 18 in the closed position during operation of the vacuum sealer 10.

In a conventional vacuum sealer, the heating ribbon is contiguous and uniform along the entire length of the sealing bar, such that the entire width of the bag is sealed at once. In contrast, vacuum sealers of preferred embodiments of the present disclosure comprises a heating ribbon that is divided into two or more segments, which may or may not be of equal length. However, the combined length of the segments still equals the entire length of the sealing bar, such that the entire width of the bag is sealed once all segments of the heating ribbon have been heated. The segments may be activated at different times to seal different portions of a bag at different times. Having the heating ribbon comprise two or more segments that may be activated at different times enables a portion of the open end of the bag to be sealed before vacuuming and the remainder of the open end of the bag to be sealed after vacuuming. Typically, the portion of the open end of the bag that is sealed before vacuuming is much greater than the portion of the open end of the bag that is sealed after vacuuming. In other words, only a small portion of the end of the bag remains unsealed during vacuuming. Having only a small portion of the end of the bag unsealed during vacuuming helps reduce the amount of liquid pulled out of the bag during vacuuming. Further, having only a small portion of the end of the bag unsealed during vacuuming reduces the length of the wet portion of the bag to be heat-sealed, which improves sealing quality.

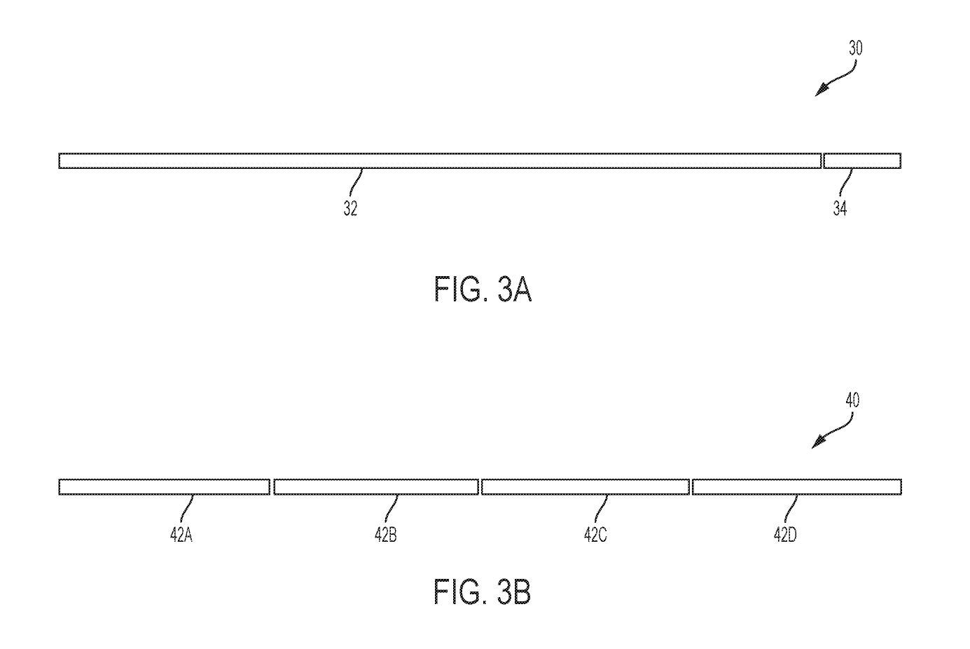

FIGS. 3A and 3B illustrate two different preferred heating ribbon options. FIG. 3A illustrates a heating ribbon 30 (such as may be part of the sealing bar 22) having two, unequal length segments—a first or longer heating ribbon segment 32 and a second or shorter heating ribbon segment 34. Each of the longer heating ribbon segment 32 and the shorter heating ribbon segment 34 has a predetermined length, and shares a common longitudinal axis (i.e., the segments are linearly aligned). In an embodiment, the predetermined length of the longer heating ribbon segment 32 is at least slightly longer, and preferably substantially longer, than the predetermined length of the shorter heating ribbon segment 34. In one exemplary embodiment of the present disclosure, the longer segment may be about nine inches in length and the shorter segment may be about 2.5 inches in length (these lengths are for illustrative purposes only, other lengths may be used).

In operation of a vacuum sealer having a heating ribbon as illustrated in FIG. 3A, the first or longer heating ribbon segment 32 is activated first via application of power by a power supply 19 (shown in phantom in FIG. 2) to seal a correspondingly long portion of the open end of the bag, leaving a shorter portion unsealed. After the longer segment 32 has sealed a portion of the bag, the vacuum pump is activated to evacuate air from the bag via the remaining, relatively short, unsealed portion of the bag. After the air has been evacuated from the bag, the second or shorter heating ribbon segment 34 is activated via application of power by the power supply 19 to seal the remaining correspondingly short unsealed portion of the bag. Alternately, the user can elect to have the first and second heating ribbon segments 32, 34 activate at the same time, thereby fully sealing the length of the polymeric or plastic bag in a single step. Optionally, the vacuum pump may also be run (activated to evacuate air from a bag) (1) while the longer heating ribbon segment 32 is sealing the first, longer section of the open end of the bag, (2), while the shorter heating ribbon segment 34 is sealing the second, shorter section of the open end of the bag, and/or (3) both. While FIG. 3A, for illustrative purposes, shows the longer heating ribbon segment 32 slightly spaced apart from the shorter hearing segment 34, in a preferred embodiment there is little or no gap between the two heating ribbon segments 32,34, such that the entire end of the bag is sealed after power is applied to both heating ribbon segments 32,34, such that the vacuum inside the bag is maintained.

FIG. 3B illustrates a preferred heating ribbon 40 (such as may be part of sealing bar 22) having four, generally equal length segments 42A, 42B, 42C, 42D (any suitable number of such segments may be used). Each of the heating ribbon segments 42A, 42B, 42C, 42D has a predetermined length, and shares a common longitudinal axis (i.e., the segments 42A, 42B, 42C, 42D are linearly aligned). In an embodiment, the predetermined length of each of the heating ribbon segments 42A, 42B, 42C, 42D is substantially equal. In one exemplary embodiment of the present disclosure, each segment may be about 2⅞ inches in length (these lengths are for illustrative purposes only, other lengths may be used).

In operation of a vacuum sealer having a heating ribbon as illustrated in FIG. 3B, three of the four heating ribbon segments 42A, 42B, 42C (i.e., all but one of the segments) are activated serially or sequentially (i.e., one at a time) to seal a correspondingly long portion of the open end of a bag, leaving a shorter portion (i.e., the portion of corresponding to the fourth heating ribbon segment 42D) unsealed. The longer portion of the open end of the bag may be sealed by having multiple heating ribbon segments activated at the same time, rather than serially. However, such concurrent activation of multiple heating ribbon segments typically results in an undesirably high electrical power requirement. Serially activating the multiple equal length heating ribbon segments results in a more uniform power requirement during the sealing process.

After the three heating ribbon segments 42A, 42B, 42C have sealed a long portion of the bag, the vacuum pump is activated to evacuate air from the bag via the remaining, relatively short, unsealed portion of the bag. After the air has been evacuated from the bag, the remaining heating ribbon segment 42D is activated to seal the remaining correspondingly short unsealed portion of the bag. Alternately, the user can elect to have all heating ribbon segments 42A, 42B, 42C, 42D activate at the same time, thereby fully sealing the length of the polymeric or plastic bag in a single step. Optionally, the vacuum pump may also be run (activated to evacuate air from a bag) (1) while the three heating ribbon segments 42A, 42B, 42C are sealing the first, longer section of the open end of the bag, (2) while the heating ribbon segment 42D is sealing the second, shorter section of the open end of the bag, and/or (3) both. While FIG. 3B, for illustrative purposes, shows the four heating ribbon segments 42A, 42B, 42C, 42D slightly spaced apart from each other, in a preferred embodiment there is little or no gap between the heating ribbon segments such that the entire end of the bag is sealed after power is applied to all heating ribbon segments, such that the vacuum inside the bag is maintained.

While the heating ribbon segments that seal the longer portion of the bag are typically activated in order from left to right or from right to left (i.e., sequentially), the heating ribbon segments may be activated in any suitable order. While the heating ribbon segment that seals the shorter portion of the bag is typically either the rightmost segment 42D (as illustrated in FIG. 3B) or the leftmost segment 42A, such a heating ribbon segment may be located in any position, such as one of the middle heating ribbon segments 42B, 42C.

To express more generically the operation of a vacuum sealer with multiple heating ribbon segments, the vacuum sealer may be considered to have N heating ribbon segments (where N is any positive integer greater than one, although practically N would typically not be greater than about six or so). To seal a longer portion of the open end of a bag, heating ribbon segments 1 through N-1 are activated serially or sequentially. After the air is evacuated from the bag, heating ribbon segment N is activated to seal the remaining, shorter portion of the open end of the bag, so that the entire end of the bag is sealed side to side.

Functionally, having two unequal length heating ribbon segments (as in FIG. 3A) provides shorter sealing time and better wet sealing performance than having multiple equal-length heating ribbon segments. However, having two or more equal length heating ribbon segments (as in FIG. 3B) may simplify the power supply of the vacuum sealer, as each equal length heating ribbon segment may have the same power requirement. The shorter the length of the heating ribbon segments (i.e., the greater the value of N number of heating ribbon segments), the more the wet vacuuming performance increases due to the reduction in size of the “wet” section of polymeric or plastic bag remaining to be sealed.

In both vacuum sealers with conventional heating ribbons and vacuum sealers of embodiments of the present disclosure having multi-segment heating ribbons, the opposing free ends of the heating ribbon are electrically connected to a power supply to provide electricity to the heating ribbon to cause the heating ribbon to heat up. Such electrical connections may utilize terminals crimped to the ends of the heating ribbons and soldered to corresponding lead wire. The electrical connection at one end of the heating ribbon is typically spring-loaded to allow the ribbon to expand/contract during heat cycling.

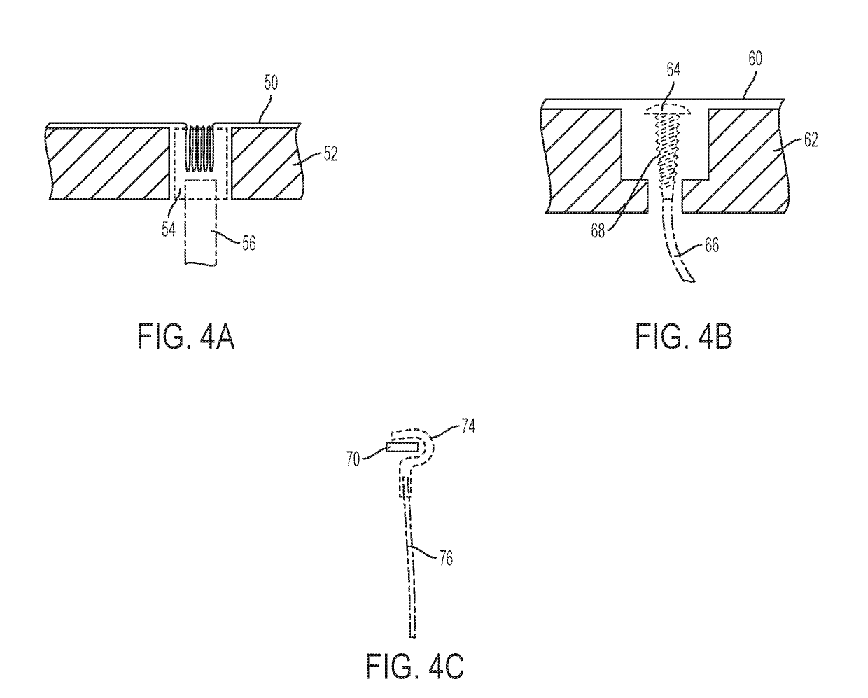

The multi-segment heating ribbon of embodiments of the present disclosure may require additional electrical connection(s) in-between the free ends. Specifically, there may need to be an electrical connection between each segment in addition to the electrical connections at the opposing ends. To energize any particular segment of the heating ribbon, the power supply is switched to cause electrical current to flow between the immediately adjacent electrical connections on either side of the heating ribbon segment to be energized. Creating the required electrical connection(s) along the length of the heating ribbon is more technically challenging than the electrical connections at the opposing ends of the heating ribbon. FIGS. 4A-4C illustrate three possible mechanisms for creating the required electrical connection(s) along the length of the heating ribbon. In FIG. 4A, a portion of the heater ribbon 50 is folded together within a gap in a heater support bar 52, and a crimp connector 54 attaches a lead wire 56 to the folded heater ribbon 50. The lead wire 56 is connected to the crimp connector 54 in any suitable manner (e.g., crimped, soldered, etc.). Multiple folds of the heater ribbon 50 may be used to reduce resistance and heat at the connection.

In FIG. 4B, the lead wire 66 is connected to a spring-loaded terminal pin 64 in any suitable manner (e.g., crimped, soldered, etc.). A spring 68 biases the pin 64 upwardly so that the head of the pin 64 stands proud of a heater support bar 62. When the lid (not shown) is closed, the thermally insulating backing strip (not shown) presses against the heating ribbon 60 and pin 64 to ensure good contact. The length and diameter(s) of the pin(s) may be predetermined to help limit the temperature of the pin at the lead-wire connection. This design allows the heating ribbon to move independently of the pin 64 during expansion and contraction.

In FIG. 4C (shown in cross-section looking down a length of a heater ribbon 70), the lead wire 76 is connected to a terminal 74 in any suitable manner (e.g., crimped, soldered, etc.). The terminal 74 is preferably wrapped around or crimped onto the heater ribbon 70.

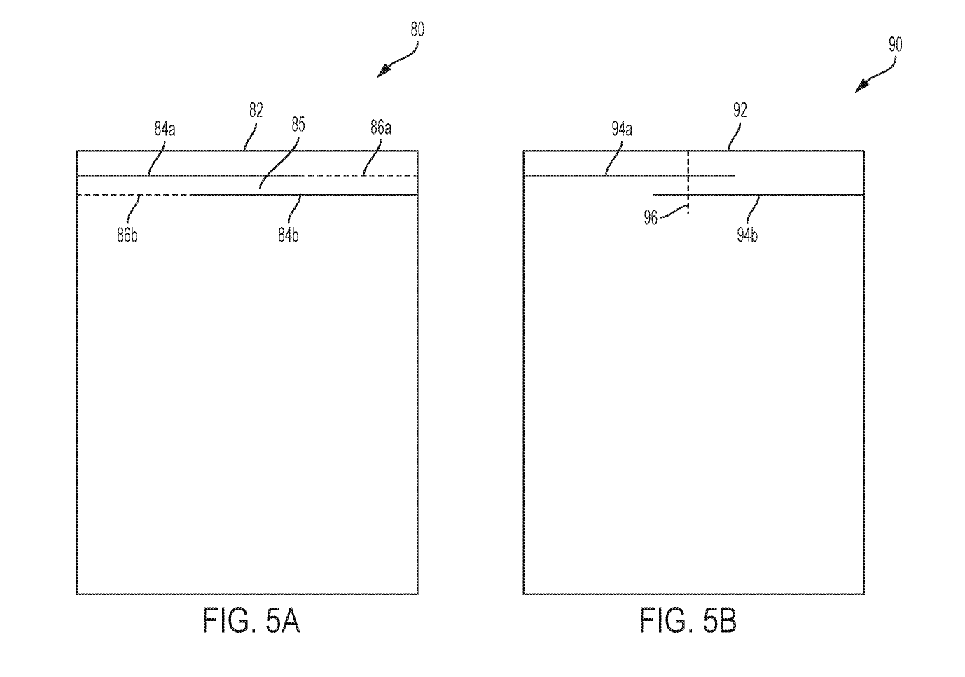

Rather than using a single linear seal that is accomplished in two or more steps, as described above in FIGS. 3A and 3B, a vacuum sealer of a second preferred embodiment may alternately use two substantially parallel, offset seals. Referring now to FIG. 5A, a polymeric bag 80 has an open end 82 at which two parallel but offset seals 84a, 84b (indicated by the solid lines) are created prior to vacuuming. The two seals 84a, 84b create a small open passage 85 between medial portions through which air may exit the bag 80 during vacuuming. After the air has been evacuated from the bag 80, the two parallel offset seals are then completed by continuing the seals along as indicated by dashed lines 86a, 86b.

The creation of the parallel seals may be accomplished via a vacuum sealer having many of the same components as described above. However, instead of a single sealing bar with linearly aligned heating ribbon segments (as shown in FIGS. 3A and 3B), the vacuum sealer (as shown in FIG. 6A) has a second sealing bar 67 secured to the underside of the lid or the corresponding top surface of the lower portion of the vacuum sealer housing, which is spaced apart from the first sealing bar 61 and generally parallel to the first sealing bar 61. The second sealing bar 67 has one or more additional heating ribbon segments 69, 71, each having a predetermined length and a common longitudinal axis (i.e., linear alignment). In an embodiment, the predetermined length of one of the heating ribbon segments on the second sealing bar 67 is longer than the other. The first sealing bar 61 and the second sealing bar 67 are aligned in a manner such that a portion of the first or longer heating ribbon segment 63 on the first sealing bar 61 at least partially overlaps a portion of the third or longer heating ribbon 69 on the second sealing bar 67, while the second and forth, or shorter heating ribbon segments 65, 71, of the first and second sealing bars 61, 67 do not overlap.

Referring now to FIG. 5B, a bag 90 has an open end 92 at which two parallel but offset seals 94a, 94b (indicated by the solid lines) are created prior to vacuuming. The two seals 94a, 94b create a small passage between medial portions through which the vacuumed air exits the bag 90 during vacuuming. After the air has been evacuated from the bag 90, a single seal 96 (indicated by the dashed line) is created which intersects both of the parallel offset seals 94a, 94b, thereby closing off the passage between the medial portions. The single intersecting seal 96 may be perpendicular to the parallel offset seals 94a, 94b as indicated, or may be at any suitable angle.

The creation of the offset parallel seals and central final seal may be accomplished via a vacuum sealer having many of the same components as described above. However, instead of a single sealing bar with linearly aligned heating ribbon segments (as shown in FIGS. 3A and 3B), the vacuum sealer has (as shown in FIG. 6B) a first sealing bar 73 with a first heating ribbon segment 75 not spanning the entire width of the first sealing bar 73, and a second sealing bar 77 secured to the underside of the lid or the corresponding top surface of the lower portion of the vacuum sealer housing spaced apart from and generally parallel to the first sealing bar 73, the second sealing bar 77 having a second heating ribbon segment 79 also not spanning the entire width of the second sealing bar 77. The first heating ribbon 75 and the second heating ribbon 79 are secured to the underside of the lid or the corresponding top surface of the lower portion of the vacuum sealer housing such that a portion of the first heating ribbon segment 75 laterally overlaps at least a portion of the second heating ribbon segment 79. The vacuum sealer includes a third sealing bar 81 secured to an underside of the lid or the corresponding top surface of the lower portion of the vacuum sealer housing proximate to the overlapping portions of the first sealing bar 73 and the second sealing bar 77, the third sealing bar 81 having a third heating ribbon segment 83 secured to the underside of the lid or the corresponding top surface of the lower portion of the vacuum sealer housing such that the third heating ribbon segment 83 intersects with both the first heating ribbon segment 75 and the second heating ribbon segment 79, so that the entire end of the bag is sealed from side to side.

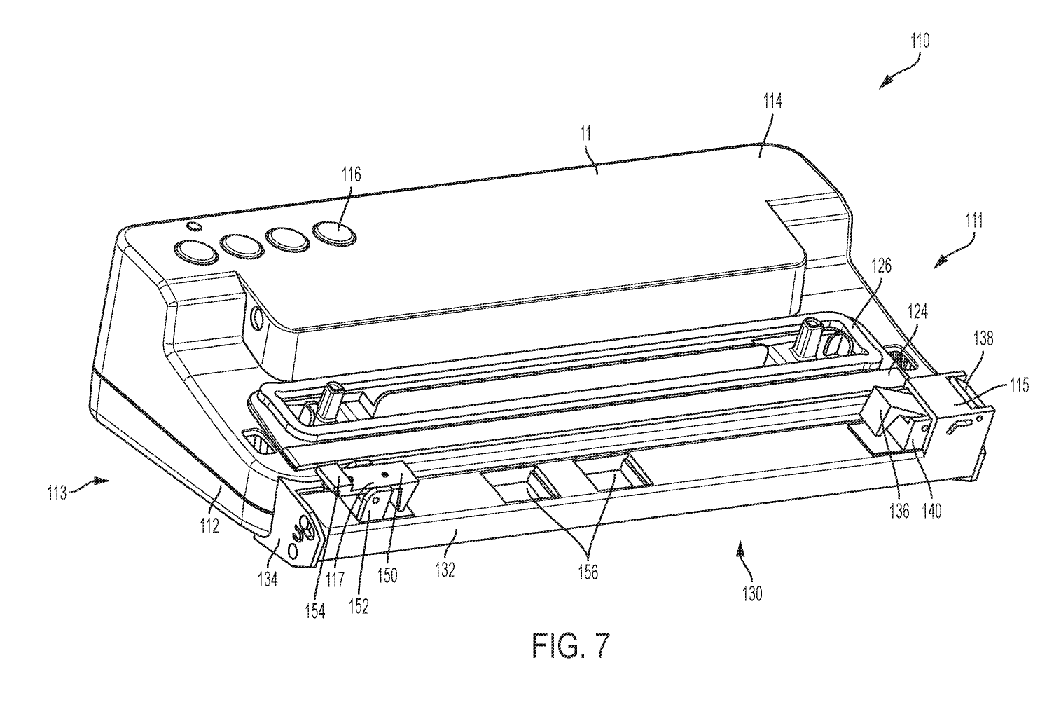

In conventional vacuum sealers, it is difficult to maintain a bag in the correct position for vacuuming and sealing as the lid is closed. FIGS. 7-9 illustrate a vacuum sealer 110 of a second preferred embodiment of the present disclosure. The vacuum sealer 110 comprises a lower portion 112 adapted to sit on a surface (such as a countertop) during use, an upper portion 114, a control panel 116, and a lid (not illustrated for clarity). A sealing bar (not illustrated) is positioned on the underside of the lid. The top surface of the lower portion 112 has a thermally insulating backing strip 124 that is positioned such that a polymeric or plastic bag is sandwiched between the sealing bar and the thermally insulating backing strip 124 when the lid is in the closed position. In an alternate embodiment, the thermally insulating backing strip 124 is located in the lid 18, while the sealing bar (or, as shown in FIGS. 6A and 6B, the sealing bars) is/are located in the corresponding top surface of the lower portion 112 of the housing. A vacuum chamber 126 seals around the open end of the bag when the lid is in the closed position. During operation of the device, air is vacuumed out of the vacuum chamber 126, which in turn vacuums air out of the bag via the open bag end.

Advantageously, the vacuum sealer 110 comprises a bag holding mechanism 130 that is affixed to (optionally selectively affixed) or integral with the lower portion 112. The bag holding mechanism 130 comprises a main body 132, having a first end 111 and a second end 113, affixed to the lower portion 112 via opposing end brackets 134. The bag holding mechanism 130 further comprises two clamps for holding a bag in place. The first or right side clamp, which is part of a first latch mechanism 115 movably disposed on the first end 111 of the main body 132, is movable laterally (as described below) and biased outwardly to apply tension to the bag to help remove wrinkles for better sealing. The second or left side clamp, which is part of a second latch mechanism 117 disposed proximate to the second end 113 of the main body 132 in line with the first latch mechanism 115, in the present embodiment, does not move laterally. Optionally, the first, laterally movable clamp could be on the left side or on both sides. Alternatively, the second, non-laterally-movable clamp could be on the right side or on both sides.

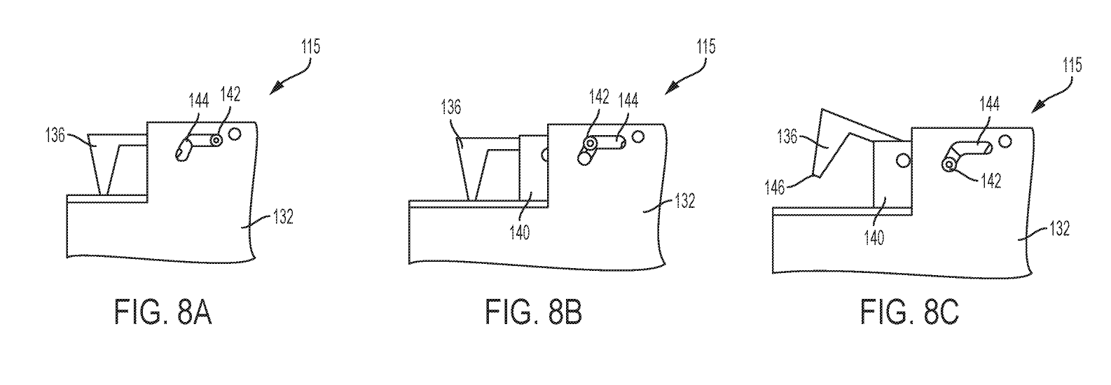

The first clamp 136 (shown on the right side of the device, although the first clamp 136 could be on either side or both sides) slidingly engages with the main body 132 by riding on a carriage 140 that slides medially and laterally along the main body 132. In this way, the distance between the first latch mechanism 115 and the second latch mechanism 117 is adjusted. As shown in FIGS. 8A-8C, the first clamp 136 pivots up and down about a pivot point 142 that rides in a channel 144. Movement of the first clamp 136 is controlled by a first button 138. The sliding carriage 140, pivot point 142, and channel 144 enables the first clamp 136 to move up and down, and also out and in for loading, holding, and removing a bag. FIGS. 8A-8C illustrate the functioning of the first latch mechanism 115 through the movement of the first clamp 136 for loading, holding, and removing a bag. FIG. 8A shows the first clamp 136 in the closed or clamped position, in which the first clamp 136 is in its lateral-most position and the distal holding surface 146 is down against the main body 132. The position shown in FIG. 8A is the default or starting position, and the position the first clamp 136 is in when holding a bag to be vacuumed/sealed. When the first button 138 is pressed, the carriage 140 and therefore the first clamp 136 moves medially, as shown in FIG. 8B. When the pivot point 142 reaches the bend in the channel 144, the distal (or medial) end of the first clamp 136 is forced to pivot upwardly, as shown in FIG. 8C. The first button 138 includes a latching mechanism, such that the first clamp 136 and carriage 140 remain in the position shown in FIG. 8C until the first button 138 is pressed again (similar to the button mechanism in a retractable pen). In an embodiment, this latching mechanism may be omitted, such that the clamp moves back to the default position shown in FIG. 8A when the first button 138 is released. When the first button 138 is pressed again, the carriage 140, and therefore the first clamp 136, moves laterally and the interaction between the pivot point 142 and the channel 144 causes the first clamp 136 to pivot downwardly and return to the position shown in FIG. 8A.

Although the second clamp 150 is shown on the left side of the device, the second clamp 150 could be on either side or both sides. The second clamp is pivotably mounted on a mount 152. The second clamp 150 may not move laterally, but rather pivots upwardly and downwardly about the mount 152 as the second button 154 is, respectively, depressed and released. The second clamp 150 is biased downwardly into the position shown in FIG. 7 via an internal spring (not shown). The second clamp 150 may optionally include a latching mechanism such that the second clamp 150 remains in the upward or open position until the second button 154 is pressed again. The second clamp 150 and mount 152 may be repositioned into any one of a plurality of different mounting locations 156 to accommodate different width bags. Alternatively, the second clamp 150 and mount 152 may be slidingly engaged with the main body 132 to allow the second clamp 150 and its mount 152 to be moved into many different positions.

To load a bag for vacuuming/sealing, the first button 138 is pushed to open the first clamp 136 (i.e., move the first clamp 136 from the position shown in FIG. 8A to the position shown in FIG. 8C). The second button 154 is pushed and held to open the second clamp 150. A bag is then placed in the correct position for vacuuming/sealing, ensuring that the opposing side edges are positioned under the first and second clamps 136, 150. The second button 154 is then released such that the second clamp 150 returns to a closed position (shown in FIG. 7). The first button 138 is also depressed again to cause the first clamp 136 to return to a closed position (shown in FIG. 8A). As the first clamp 136 returns to a closed position, the distal holding surface 146 contacts the top surface of the bag and then applies a lateral tensioning force as the first clamp 136 moves laterally (outwardly). This tensioning force helps remove wrinkles for better sealing of the plastic or polymeric bag.

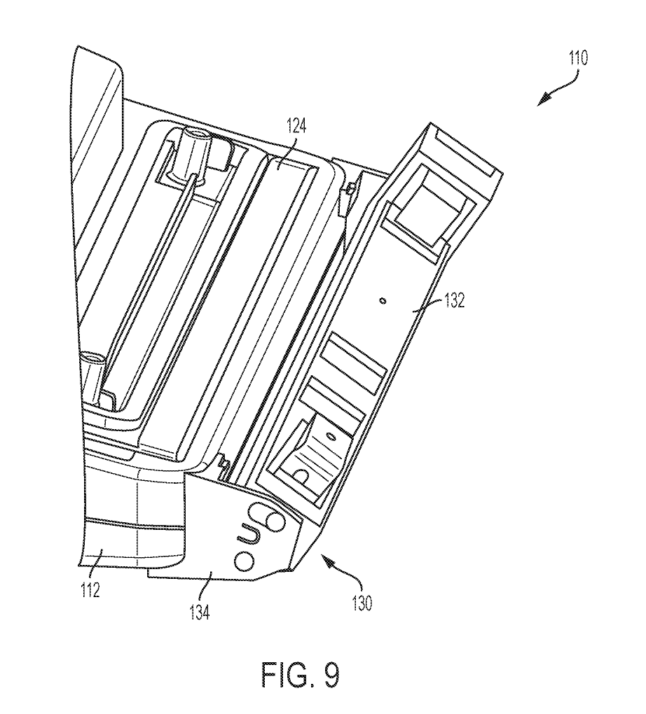

Sometimes it is desirable to form two parallel seals on a same end of the bag without the need for multiple sealing bars. It is difficult to form two parallel seals by manually moving the bag into the two different required positions. To facilitate, the main body 132 of the latching mechanism 130 is movable between two positions, such that a first seal is formed when the latching mechanism 130 is in a first position (such as is shown in FIG. 7) and a second seal may be formed when the latching mechanism 130 is in a second position (such as is shown in FIG. 9). The latching mechanism 130 may be pivotable between the first and second position, as shown in FIGS. 7 and 9, by affixing the main body 132 to the vacuum sealer 110 via one or more end brackets 134, which allow the main body 132 to rotate to one or more positions. Alternatively, the mechanism 130 may be slidable between the first and second position (not illustrated). The difference between the first and second positions of the latching mechanism may be predetermined to provide the desired distance between the first and second seals.

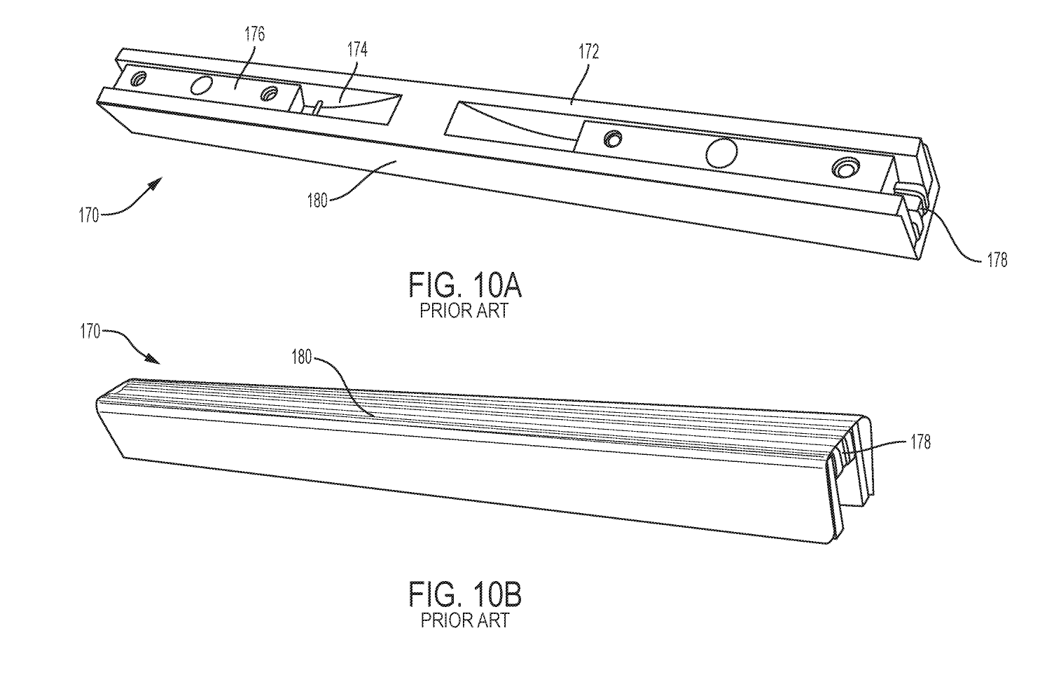

FIGS. 10A and 10B illustrate a prior art sealing bar of a vacuum sealer. As described above, the sealing bar of a vacuum sealer is the component that applies heat to the bag to seal the bag, and can be located either in the lid or the corresponding top surface of the lower portion of the vacuum sealer housing. The prior art sealing bar 170 comprises a support bar 172 with two opposing longitudinal channels 174 on a same long side of the sealing bar 170 (the side of the sealing bar 170 with the channels conventionally referred to as the bottom). A mounting bracket 176 is recessed into each channel 174. The mounting brackets 176 is used to affix the sealing bar 170 to the lid of a vacuum sealer. Opposing ends of a heating ribbon 178 are located within the channels 174 (not visible), where necessary electrical connections are made. The heating ribbon 178 exits one open end of the support bar 172 (the right side of FIG. 10A), runs along the flat top of the support bar 172 (the heating ribbon is not visible where it runs along the top), and enters the other open end of the support bar (not visible, but on the left side of FIG. 10A). The top and the two opposing long sides of the support bar 172 are covered with a Teflon-based high-temperature tape 180. Because of the open ends and the channels 174 in the conventional sealing bar 170, dirt and debris (including solid and liquid foodstuffs that come out of the bag during the sealing process) undesirably accumulate within the sealing bar 170.

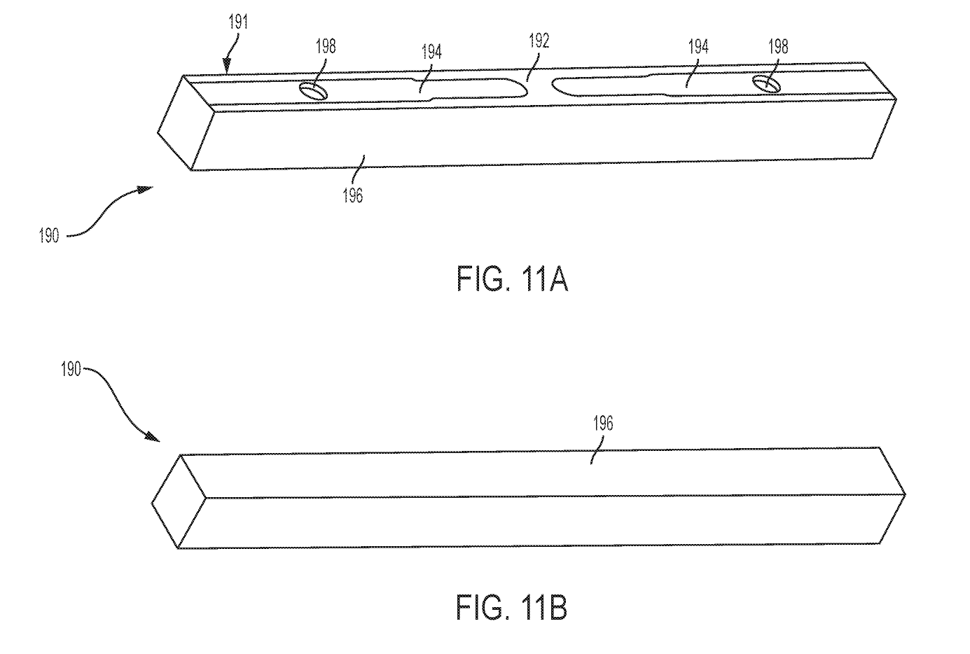

FIGS. 11A and 11B illustrate an improved sealing bar of a vacuum sealer, according to an alternative embodiment of the present disclosure. Generally, the improved sealing bar 190 has a support bar 192 having four long surfaces and two short surfaces, and two opposing longitudinal channels (not visible) on a same long side 191 of the improved sealing bar 190. In the improved sealing bar 190, the openings of the opposing longitudinal channels are sealed with channel covers 194 (the side of the improved sealing bar 190 with the channels and channel covers 194 is referred to as the bottom). The channel covers 194 fit snugly in the respective openings of the channels to help prevent dirt or debris from getting into the channels. The channel covers 194 each define a mounting hole 198 that is aligned with a mounting hole of a respective mounting bracket (not visible) recessed into each channel to enable the improved sealing bar 190 to be affixed to the lid of a vacuum sealer. The channel covers 194 may be constructed of any suitable material, such as silicone rubber or nylon. The improved sealing bar 190 of embodiments of the present disclosure also comprise a heating ribbon (not visible) positioned as in the prior art sealing bar. However, the heating ribbon of the improved sealing bar 190 is not exposed because the improved sealing bar 190 has a Teflon-based high-temperature tape 196 that covers five of the six sides of the improved sealing bar 190 (the only side not covered by the high-temperature tape 196 is the bottom, otherwise defined as the long surface displaying the one or more mounting holes 198). By wrapping the high-temperature tape 196 around the ends of the improved sealing bar 190, the improved sealing bar 190 does not have open ends in which dirt and debris can accumulate.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

What is claimed is:

1. A vacuum sealer, comprising:
a housing having an upper portion and a lower portion, the lower portion having a top surface;
a lid pivotably attached to the housing, and movable between a closed position, covering at least a portion of the top surface, and an open position, exposing the top surface;
wherein the top surface defines a first cavity and the lid defines an opposing second cavity in an underside of the lid, the first cavity and the second cavity being engaged together or to one another in the closed position of the lid to form a sealed vacuum chamber therebetween;
a pump in fluid communication with the vacuum chamber to withdraw air from the vacuum chamber and create a vacuum therein, the sealed vacuum chamber being configured to receive an open end of a polymeric bag therebetween to withdraw air therefrom via activation of the pump;
a sealing bar having a first heating ribbon and a second heating ribbon, the first heating ribbon and the second heating ribbon each having a predetermined length and a common longitudinal axis;
a thermally insulating backing strip opposing the first heating ribbon and second heating ribbon, the sealing bar and the backing strip being configured to heat seal a portion of the polymeric bag positioned therebetween through the application of power from a power supply to the first heating ribbon and the second heating ribbon.

2. The sealer as recited in claim 1, wherein the predetermined length of the first heating ribbon is at least slightly longer than the predetermined length of the second heating ribbon.

3. The sealer as recited in claim 1, wherein the power supply is configured to apply power sequentially to the first heating ribbon, then to the second heating ribbon after the pump withdraws air from the open end of the polymeric bag.

4. The sealer as recited in claim 1, wherein the sealing bar further comprises a third heating ribbon and a fourth heating ribbon, each having a predetermined length and a common longitudinal axis with the first heating bar and second heating bar.

5. The sealer as recited in claim 4, wherein the power supply further supplies power to the third heating ribbon and the fourth heating ribbon.

6. The sealer as recited in claim 5, wherein the power supply is configured to apply power sequentially to one or more of the first, second, and third heating ribbons, then to the fourth heating ribbon after the pump withdraws air from the open end of the polymeric bag.

7. The sealer as recited in claim 4, wherein the predetermined lengths of the first, second, third, and fourth heating elements are substantially equal.

8. The sealer as recited in claim 1, further comprising a second sealing bar spaced apart from the first sealing bar and generally parallel to the first sealing bar, the second sealing bar having a third heating ribbon and a fourth heating ribbon, the third heating ribbon and the fourth heating ribbon each having a predetermined length and a common longitudinal axis;
wherein the predetermined length of the first heating ribbon is longer than the predetermined length of the second heating ribbon;
wherein the predetermined length of the third heating ribbon is longer than the predetermined length of the fourth heating ribbon;
wherein the first sealing bar and the second sealing bar are aligned in a manner such that a portion of the first heating ribbon at least partially overlaps a portion of the third heating ribbon, while the second heating ribbon and the fourth heating ribbon do not overlap.

9. The sealer as recited in claim 8, wherein the power supply is configured to apply power to the first and third heating ribbons, then to the second and fourth heating ribbons after the pump withdraws air from the open end of the polymeric bag.

10. A vacuum sealer, comprising:
a housing having an upper portion and a lower portion, the lower portion having a top surface;
a lid pivotably attached to the housing, and movable between a closed position, covering at least a portion of the top surface, and an open position, exposing the top surface;
wherein the top surface defines a first cavity and the lid defines an opposing second cavity in an underside of the lid, the first cavity and the second cavity being engaged in the closed position of the lid to form a sealed vacuum chamber therebetween;
a pump in fluid communication with the vacuum chamber to withdraw air from the vacuum chamber and create a vacuum therein, the sealed vacuum chamber being configured to receive an open end of a polymeric bag therebetween to withdraw air therefrom via activation of the pump;
a first sealing bar having a first heating ribbon;
a second sealing bar spaced apart from and generally parallel to the first sealing bar, the second sealing bar having a second heating ribbon, the first heating ribbon and the second heating ribbon are secured such that a portion of the first heating ribbon laterally overlaps at least a portion of the second heating ribbon;
a third sealing bar secured proximate to the overlapping portions of the first sealing bar and the second sealing bar, the third sealing bar having a third heating ribbon secured such that the third heating ribbon intersects with both the first heating ribbon and the second heating ribbon;
a thermally insulating backing strip opposing the first, second, and third heating ribbons, the sealing bars and the backing strip being configured to heat seal a portion of the polymeric bag positioned therebetween through the application of power from a power supply to the sealing bars.

11. The sealer as recited in claim 10, wherein the third sealing bar is secured such that the third sealing bar is perpendicular to the first sealing bar and the second sealing bar.

12. The sealer as recited in claim 10, wherein the power supply is configured to apply power to the first and second heating ribbons, then to the third heating ribbon after the pump withdraws air from the open end of the polymeric bag.

13. A vacuum sealer, comprising:
a housing having an upper portion and a lower portion, the lower portion having a top surface;
a lid pivotably attached to the housing, and movable between a closed position, covering at least a portion of the top surface, and an open position, exposing the top surface;
wherein the top surface defines a first cavity and the lid defines an opposing second cavity in an underside of the lid, the first cavity and the second cavity being engaged in the closed position of the lid to form a sealed vacuum chamber therebetween;
a pump in fluid communication with the vacuum chamber to withdraw air from the vacuum chamber and create a vacuum therein, the sealed vacuum chamber being configured to receive an open end of a polymeric bag therebetween to withdraw air therefrom via activation of the pump;
at least one sealing bar, the at least one sealing bar having at least two heating ribbons;
wherein the at least two heating ribbons are each independently connected to a power supply such that the at least two heating ribbons can expand and contract during activation;
a thermally insulating backing strip opposing the at least two heating ribbons, the at least one sealing bar and the backing strip being configured to heat seal a portion of the polymeric bag positioned therebetween through the application of power from the power supply to the at least two heating ribbons.

14. The sealer as recited in claim 13, wherein each of the at least two heating ribbons comprises at least one heating ribbon fold, each heating ribbon fold being inserted into a gap in a heater support bar;
wherein each of the at least two heating ribbons is independently connected to the power supply via attachment of one or more lead wires to each of the heating ribbon folds via a crimp connector, the lead wire being also connected to the power supply.

15. The sealer as recited in claim 13, wherein each independent connection of the at least two heating ribbons comprises:
a lead wire, at one end connected to the power supply, at the other end connected to a spring-loaded terminal pin, the spring-loaded terminal pin comprising a spring and a pin;
wherein the spring biases the pin upwardly such that a head of the pin extends beyond a heater support bar;
wherein upon the lid being closed, the backing strip presses against each heating ribbon and pin such that the heating ribbon physically touches the pin in order for power to be supplied.

16. The sealer as recited in claim 13, wherein each independent connection of the at least two heating ribbons comprises:
a lead wire, at one end connected to the power supply, at the other end connected to a terminal;
wherein the terminal is connected to the heater ribbon.

17. A polymeric bag holding mechanism for a vacuum sealer, comprising:
a main body having at least a first end;
a first latch mechanism movably disposed on the first end of the main body, the latch mechanism comprising:
a first clamp connected to a carriage at a first pivot point;
the carriage being disposed within a recess such that the carriage moves laterally within the recess at the depression and release of a first button;
wherein the first clamp is configured to open and close via the movement of the first pivot point within a channel as the carriage moves laterally within the recess; and
a second latch mechanism disposed on the main body in line with the first latch mechanism, the second latch mechanism comprising a second clamp connected to a mount at a second pivot point, and configured to open and close at the depression and release of a second button.

18. The holding mechanism as recited in claim 17, wherein the second latch mechanism is removably attached to the main body via one or more mounting locations embedded within the main body.

19. The holding mechanism as recited in claim 17, wherein the second latch mechanism is slidingly engaged with the main body such that the distance between the second latch mechanism and the first latch mechanism is adjusted.

20. The holding mechanism as recited in claim 17, wherein the main body is affixed to the vacuum sealer using one or more end brackets.

21. The holding mechanism as recited in claim 20, wherein the main body is configured to rotate within the one or more end brackets such that the main body can rotate to one or more positions.

22. An improved sealing bar for a vacuum sealer, comprising:
a support bar having four long surfaces and two short surfaces;
one or more opposing longitudinal channels linearly disposed within the support bar, each of the one or more opposing longitudinal channels being sealed with a channel cover, each of the channel covers having a mounting hole, each of the mounting holes facing outwardly from one of the four long surfaces;
a heating bar disposed on the long surface of the support bar opposite the long surface displaying the one or more mounting holes; and
a high temperature tape covering the heating bar and all surfaces of the support bar except for the long surface displaying the one or more mounting holes.

23. A method for using a vacuum sealer, comprising:
receiving an open end of a polymeric bag into a housing having an upper portion and a lower portion, the lower portion having a top surface, and a lid pivotably attached to the housing, and movable between a closed position, covering at least a portion of the top surface, and an open position, exposing the top surface, wherein the top surface defines a first cavity and the lid defines an opposing second cavity in an underside of the lid, the first cavity and the second cavity being engaged in the closed position of the lid to form a sealed vacuum chamber therebetween;
sealing a first portion of the polymeric bag by applying power to a first heating ribbon on a sealing bar;
applying a vacuum force to at least an unsealed, second portion of the polymeric bag by a pump in fluid communication with the vacuum chamber to withdraw air from the vacuum chamber and create a vacuum therein; and
sealing the second portion of the polymeric bag by applying power to a second heating ribbon axially aligned with the first heating ribbon on the sealing bar, such that the open end of the polymeric bag is completely sealed.

24. A method for using a vacuum sealer, comprising:
receiving an open end of a polymeric bag into a housing having an upper portion and a lower portion, the lower portion having a top surface, and a lid pivotably attached to the housing, and movable between a closed position, covering at least a portion of the top surface, and an open position, exposing the top surface, wherein the top surface defines a first cavity and the lid defines an opposing second cavity in an underside of the lid, the first cavity and the second cavity being engaged in the closed position of the lid to form a sealed vacuum chamber therebetween;
sealing a first portion of the polymeric bag by applying power to a first heating ribbon on a sealing bar;
sealing a second portion of the polymeric bag by applying power to a second heating ribbon, the second heating ribbon being generally parallel to and spaced apart from the first heating bar;
applying a vacuum force to the an unsealed third portion of the polymeric bag by a pump in fluid communication with the vacuum chamber to withdraw air from the vacuum chamber and create a vacuum therein; and
sealing the third portion of the polymeric bag by applying power to a third heating ribbon secured proximate to the first heating bar and second heating bar such that the third heating ribbon intersects with both the first heating ribbon and the second heating ribbon, such that the open end of the polymeric bag is completely sealed.
